(19) United States
(12) Patent Application Publication
(10) Pub. No.: US 2013/0138421 A1
(43) Pub. Date: May 30, 2013

(54) Automatic Human Language Translation

(71) Applicant: MICROMASS UK LIMITED, Manchester (GB)

(72) Inventor: John B. W. Moulder, Manchester (GB)

(73) Assignee: MICROMASS UK LIMITED, Manchester (GB)

(21) Appl. No.: 13/685,896

(22) Filed: Nov. 27, 2012

Related U.S. Application Data
(60) Provisional application No. 61/564,100, filed on Nov. 28, 2011.

(51) Int. Cl. G06F 17/28

(52) U.S. Cl. CPC G06F 17/28
USPC 704/3

(57) ABSTRACT

A computer device for performing automatic human language translation includes memory storing program code of an application program and program code of a translation utility. A processor executes program code of the application program configured to display localized text in a first language on a display screen of the computer device. The processor further executes program code of the translation utility configured to detect user interest in the localized text, to acquire the localized text from the display screen in automatic response to detecting the user interest in the localized text, to obtain one or more translations in a second language for the localized text in automatic response to acquiring the localized text from the screen, and to report each obtained translation for the localized text.

### RELATED APPLICATION

This application claims the benefit of and priority to co-pending U.S. provisional application No. 61/564,100, filed Nov. 28, 2011, titled “Automatic Human Language Translation,” the entirety of which application is incorporated by reference herein.

### FIELD OF THE INVENTION

The invention relates generally to automatic real-time human language translation.

### BACKGROUND

Many corporations write computer applications for use in global markets. To adapt a computer application displayed in one human language so that it displays in another language requires localization. Generally, localization involves adapting the user experience produced by the computer application into a different language of a specific country or region. In addition to translating text and strings, localization can include the reworking of other user interface elements, such as images and graphical layout.

Testing the computer application adapted for a different language has its difficulties. Often software developers are unfamiliar with the localized language and are uncertain of the meaning of user interface elements displayed when the application executes. To assist the application-testing process, pseudo-translation was developed. The pseudo-translation process produces a localized product in a synthetic language visually similar to the original language of the computer application. Execution of the computer application thus produces pseudo-translated user interface elements, which software developers can read and use to find localization problems. Testing the computer application in its pseudo-translated form gives some foresight as to how the computer application will perform when translated into a target localized language. Notwithstanding, testing the computer application in pseudo-translated form cannot eliminate the uncertainty experienced by the software developer when running the computer application in its localized form.

### SUMMARY

In one aspect, the invention features a method of performing automatic human language translation. The method comprises displaying localized text in a first language on a screen of a computer device in response to execution of an application program. User interest in the localized text is detected. The localized text is acquired from the screen of the computer device in automatic response to detecting the user interest in the localized text. One or more translations in a second language are obtained for the localized text from a dictionary in automatic response to acquiring the localized text from the screen. Each obtained translation for the localized text is reported.

In another aspect, the invention features a computer device comprising a display screen, memory storing program code of an application program and program code of a translation utility, and a processor executing program code of the application program configured to display localized text in a first language on the display screen. The processor further executes program code of the translation utility configured to detect user interest in the localized text, to acquire the localized text from the display screen in automatic response to detecting the user interest in the localized text, to obtain one or more translations in a second language for the localized text from a dictionary in automatic response to acquiring the localized text from the screen, and to report each obtained translation for the localized text.

In still another aspect, the invention features a computer program product for performing automatic human language translation. The computer program product comprises a computer-readable storage medium having computer-readable program code embodied therewith. The computer-readable program code comprises computer-readable program code configured to detect user interest in localized text displayed in a first language on a screen of a computer device in response to an execution of an application program, computer-readable program code configured to acquire the localized text from the screen of the computer device in automatic response to detecting the user interest in the localized text, computer-readable program code configured to obtain one or more translations in a second language for the localized text from a dictionary in automatic response to acquiring the localized text from the screen, and computer-readable program code configured to report each obtained translation for the localized text.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a functional block diagram of an embodiment of a computer device configured to perform automatic human language translation.

FIG. 2 is a flow diagram of an embodiment of a process for automatic language translation.

FIG. 3 is an embodiment of a user interface produced by an executing application program and a translation user interface produced by a translation utility.

### DETAILED DESCRIPTION

Computer devices or systems configured as described herein perform automatic human language translation of text displayed in a localized language to a different language, for example, Chinese to English. In general, an application program written for use in a first market requires adaptation for use in other markets of different languages. A localized language preferably refers to the language for which the resources of an application program are adapted. A resource, as used herein, preferably includes application program features such as text, images, and graphical user interface layouts. The adaptation process of the application program produces localized resources and localized text, as described in more detail below.

In brief overview, an application program runs on a computer device and produces a user interface with various resources displayed in a localized language. A translation utility executing locally on the computer device automatically acquires displayed localized text, detected as being of interest to the user, and dynamically (in real time) translates the localized text into a different language (preferably a language with which the user is sufficiently familiar). Although described herein primarily with English (or pseudo-English) as the language into which the localized language is translated, the principles apply to any two languages, for example, translating displayed Japanese text into Spanish.

In one embodiment, the user identifies the localized text of interest with a mouse, using the input device to move the cursor over the text. The translation utility employs program code for automatically capturing the localized text from the display screen when the cursor moves over the text. In response to capturing the text, a translation of the text automatically appears on the screen of the computer device. Such translations occur dynamically as the user moves the cursor across the display screen.

To integrate the translation utility with the application program that runs in the localized language, no modification to the application program is necessary, which is particularly advantageous in regulated environments where changes to the application program are prohibited. Regulated environments can be found in such industries, for example, as pharmaceutical drug discovery, food and environmental industries, forensics, and clinical industries. Within these regulated environments, the translation utility can be integrated with application programs running on analytical instruments, for example, mass spectrometers and liquid chromatographs. Integration occurs through the translation utility's use of metadata produced by the adaptation process of the application program (as previously noted, an application program written for use in a first market requires adaptation for use in other markets of different languages).

The adaptation process of the application program involves the identification of resources (e.g., text, strings, images, graphical user interface layouts) that will be displayed during the execution of the application program. Such resources are stored separately from the program code of the application program. These resources may also be translated into different languages. The identification and translation of such resources can be an automated process. During a software development build process, resources in the English language, for example, can be automatically identified and substituted with equivalent localized resources. At run time of the application program, the appropriate localized resources are loaded for the particular language in which the application program is running.

One aspect of this substitution, useful for testing the application program for purposes of adaptation into other languages, is to translate English text into pseudo-English text, whereby one or more of the characters of the English text are replaced with different, but visually similar characters, for example, accented characters. For example, the English text ‘administrator’ can be replaced with the pseudo-English text ‘ad’mi\check{n}istrator’. The visual similarity permits a viewer to understand the original meaning. When a software developer builds and runs the adapted application program, the appearance of pseudo-translated English signifies a resource that has been identified and translated. Conversely, the appearance of unmodified English text indicates that a resource has not been pseudo-translated and may still require translation.

When adapting the application program from English into a localized language, the pseudo-translation step uses a glossary that substitutes identified English resources with each localized equivalent (instead of with pseudo-English). In general, a glossary is used as part of the software-build process that produces localized versions of the application program, possibly using an automated tool. Each glossary is a data structure that maps identified resources (assigned resource identifiers or names) with their localized translations.

A glossary produced by the adaptation process of the application program can be read in reverse; that is, rather than each resource identifier being associated with a localized equivalent (as provided in the glossary), each localized equivalent is conversely associated with a resource identifier. Similarly, a glossary produced by pseudo-translation can also be read in reverse so that each pseudo-translated text (e.g., English-like text) is associated with a resource identifier. A refinement of this pseudo-translation process can alternatively produce a un-pseudo-translated glossary, wherein the original English language is retained and associated with a corresponding resource identifier.

A dictionary can be derived by combining a localized glossary with a target-language glossary: in the localized glossary, localized text is associated with a resource identifier; and in the target-language glossary, the resource identifier is, in turn, associated with target language text. In the resulting dictionary, each localized text has an associated resource identifier, which has an associated target language text (e.g., localized text→resource identifier→English text).

In another embodiment, the dictionary can be further reduced by eliminating the resource identifier, that is, it can be reduced so that each localized text has an associated target-language text (e.g., localized text→English text). The translations in this dictionary, in effect, are the reverse of the translations provided by the glossary produced by the adaptation of the application program. In practice, some localized texts are duplicated (the same localized text is displayed in several locations by the application program), and so each localized text can have one or more resource identifiers, and a resulting dictionary can map the localized text to one or more target-language texts (e.g., localized text→One or more English texts).

The mappings of localized text to target-language (e.g., English) text(s) of the dictionary can be stored in a data structure. This data structure forms the basis of the dictionary containing the set of translations of localized texts to target-language (e.g., English) texts. The storage of the dictionary need not be limited to a file. For example, the dictionary can be stored in another type of persistent storage medium, for example, a database.

The translation utility uses this reverse-translation dictionary when dynamically translating localized text into the target language. Because the dictionary derives from the original metadata of the translations of the target language to localized text (as part of the adaptation process of the application program), the translation activity thus becomes a bound problem; the translation is deterministic, unlike the more complex problem of translating any given localized text into English. Moreover, because the dictionary effectively reuses and reverses the original translations of the glossary generated by the adaptation process of the application program, the dictionary ensures an accurate translation that appropriately incorporates any context or application domain specific terminology.

The certainty of an accurate translation enables a user to move confidently about the screens produced by the application program and to activate controls—the translations that appear on the screen in response to the current cursor location, for example, confirm the identity or meaning of a particular user interface element (e.g., buttons, menus, captions, links, etc.). Personnel unfamiliar with the localized language can thus confirm correct operation of the application program based on these translations (i.e., on the correct screen, page, form, etc.) and confidently navigate through the application program execution although the program runs in an unfamiliar localized language.

Further, because the translation utility can perform translations locally on the computer device (the dictionary being locally situated at the computer device), without communicating over a network to access an external Internet-based translation service, there is no requirement for Internet access, no concern with data security or privacy issues, and no opportunity for the unintended disclosure of information, such as confidential data or trade secrets, to other parties (e.g., eavesdroppers on the network).

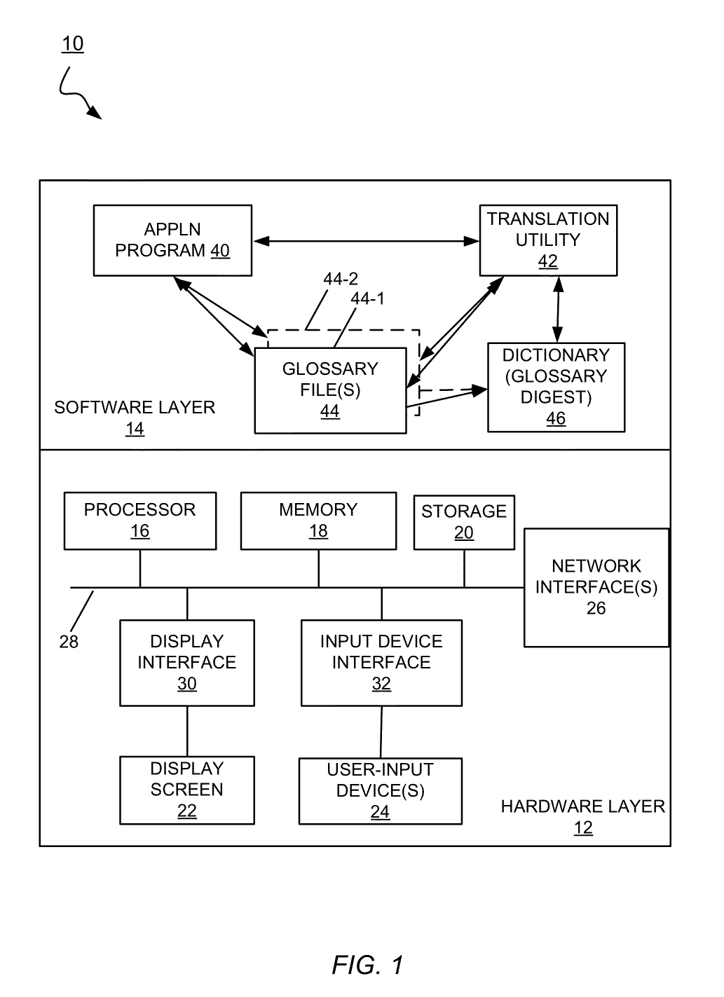

FIG. 1 shows a functional block diagram of an embodiment of a computer device (or system) 10 configured to perform automatic human language translation as described herein. Example implementations of the computer device 10 include, but are not limited to, computers (PCs and Macintosh), workstations, servers, hand-held devices, such as personal digital assistants (PDA), cellular phones, smartphones, Apple iPods™ and iPads™, Amazon KINDLEs®, mobile phones, navigation and global positioning systems, kiosks, and network terminals. The computer device 10 generally comprises a hardware layer 12 and a software layer 14.

The hardware layer 12 includes a processor 16, memory 18, storage 20, a display screen 22, user input device(s) 24, and a network interface 26. The processor 16 can be a proprietary or conventional cache-based machine, employing hardware logic, software logic, or a combination thereof in the performance of its processing tasks, such as memory access, communication-related processing, arithmetic/logical operations, and control.

The memory 18 includes non-volatile computer storage media, such as read-only memory (ROM), and volatile computer storage media, such as random-access memory (RAM). Typically stored in the ROM is a basic input/output system (BIOS), which contains program code for controlling basic operations of the computing system 10 including start-up of the computing device and initialization of hardware. Stored typically within the RAM are data and executing program code, such as application programs and program modules (e.g., DLLs or dynamic link libraries).

Storage 20 includes internal or external (or both) persistent storage devices, such as hard disk drives, SATA (serial advanced technology attachment), USB (Universal Serial Bus) devices, and network attached storage (NAS). The storage 20 can be used for persistent storage of data, databases, and files.

The display screen 22 is an electronic visual display for the computer device 10. Depending on the type of the computer device 10, embodiments of the display screen 22 include, but are not limited to, a monitor, flat-panel screen, and touch-screen.

In general, the user-input device 24 can be any peripheral device used to provide data and control signals to the computer device 10. Example embodiments of the user-input device(s) include, but are not limited to, a keyboard, a mouse, trackball, touch-pad, touch-screen, graphics tablet, microphone, light pen, joystick, heat-mapping devices, and eye-gaze tracking devices.

The network interface 26 may be configured to connect to a local area network, a wide-area network such as the Internet or World Wide Web. The computer device 10 can connect to the network through one of a variety of connections, such as standard telephone lines, digital subscriber line (DSL), asynchronous DSL, LAN or WAN links (e.g., T1, T3), broadband connections (Frame Relay, ATM), and wireless connections (e.g., 802.11(a), 802.11(b), 802.11(g), 802.11(n)).

A signal bus 28 interconnects the various hardware components of the computer device 10. The display screen 22 connects to the signal bus 28 through a display interface 30, and the user-input device(s) 24 connects to the signal bus 28 through a device interface 32. The communication between the user-input device(s) 24 and the user-input interface 32 can be over wired or wireless links.

In addition, the signal bus 28 can connect to various other components (not shown) of the computer system 10 including, for example, a memory interface, a peripheral interface (e.g., to a printer, to a CD-ROM drive), and a video interface. Although shown as a single bus, the signal bus 28 can comprise multiple separate busses. Example implementations of the signal bus 28 include, but are not limited to, a Peripheral Component Interconnect (PCI) bus, an Industry Standard Architecture (ISA) bus, an Enhanced Industry Standard Architecture (EISA) bus, and a Video Electronics Standards Association (VESA) bus.

The software layer 14 includes an application program 40, a translator utility program 42, one or more glossary files 44, and a dictionary 46. The application program 40 is generally representative of any application program adapted for a localized language and undergoing dynamic translation as described herein. Execution of the application program 40 produces a graphical user-interface, within which are displayed various localized resources or user-interface elements, including for example images, text (strings), menus, and captions. Although only a single dictionary 46 is shown, multiple dictionaries can be associated with the application program 40, each dictionary 46 providing a different target language into which the localized language of the application program 40 is translated.

The translator utility program 42, when executed while the application program 40 is running, dynamically translates select localized user-interface elements presented on the display screen 22 by the application program 40. The translator utility program 42 then reports the translations to the user, preferably by displaying the translations on the display screen 22. In another embodiment, the translator utility program 42 can report the translations audibly instead of or in addition to displaying the translations on the display screen 22. Although shown and described as separate independent programs, the application program 40 and translator utility program 42 can both be incorporated in a single application program.

The one or more glossary files 44 derive from the adaptation process of the application program 40 into a localized language, as described above. The languages associated with the one or more glossary files 44 depend upon the languages supported by the application program 40. Each glossary file 44 can be associated with a computer-readable program module (DLL file) containing resource identifiers and a localized translation for each of the identified resources. The one or more glossary files 44 can associate resource identifiers with pseudo-translations (e.g., pseudo-English). For generating the dictionary 46, as described below, the one or more glossary files 44 can comprise multiple files, for example, one or more localized language glossary files 44-1 and one or more target language glossary files 44-2, or a single glossary file.

The dictionary 46 is a data structure arranged such that a given localized text is associated with a list of matching texts translated into a different language (e.g., English). In one embodiment, each localized language, including pseudo-languages, has its own separate dictionary 46. Separate dictionaries for different languages can be advantageous for performance (i.e., translation responsiveness or speed), sizing (i.e., dynamic and persistent memory usage), and the avoidance of ambiguity (e.g., among languages with similar words). Substituting a different dictionary 46 for use in conjunction with the application program 40 and translation utility program 42 operates to change the target language into which the localized language displayed by the application program 40 is translated.

In one embodiment, each particular dictionary 46 derives from a localized language glossary file 44-1 and a target language glossary file 44-2. For example, a dictionary 46 that translates Japanese to pseudo-English derives from the combination of a Japanese localized language glossary file 44-1 and a pseudo-English target language glossary file 44-2. As another example, a dictionary 46 that translates from French to Spanish derives from a combination of a French localized language glossary file 44-1 and a Spanish target language glossary file 44-2. Alternatively, the localized language glossary file 44-1 and target language glossary file 44-2 are part of a single glossary file. The one or more glossary files 44 for any two languages supported by the application program 40 can be used to produce a dictionary 46 for translating between those two languages. This capability arises because each glossary file 44, irrespective of its associated language, uses the same resource identifiers for the resources of the application program 40. The resource identifiers thus enable the correlation of localized translations between different glossary files. For example, by virtue of a given resource identifier, a Chinese translation associated with the given resource identifier in a Chinese glossary file 44 correlates to the Japanese translation associated with that same resource identifier in a Japanese glossary file 44. To derive a dictionary 46 from these two Chinese and Japanese glossary files 44 entails finding matching resource identifiers in the glossary files 44. These matches serve to identify correlated Chinese and Japanese translations for each given resource identifier—and the resulting dictionary 46 for translating Chinese to Japanese (or from Japanese to Chinese, depending on which glossary file is used as the localized language glossary file 44-1 and which as the target language glossary file 44-2) is comprised of these correlated Chinese and Japanese translations.

An alternative method of deriving the dictionary 46 is to extract the resource identifiers and associated texts from the computer readable program module(s) (DLL files) containing the translated resources produced by the application software build process. In turn, these extracted resource identifiers and texts can be correlated (as just described) with resource identifiers and texts extracted from the corresponding DLL files in another language.

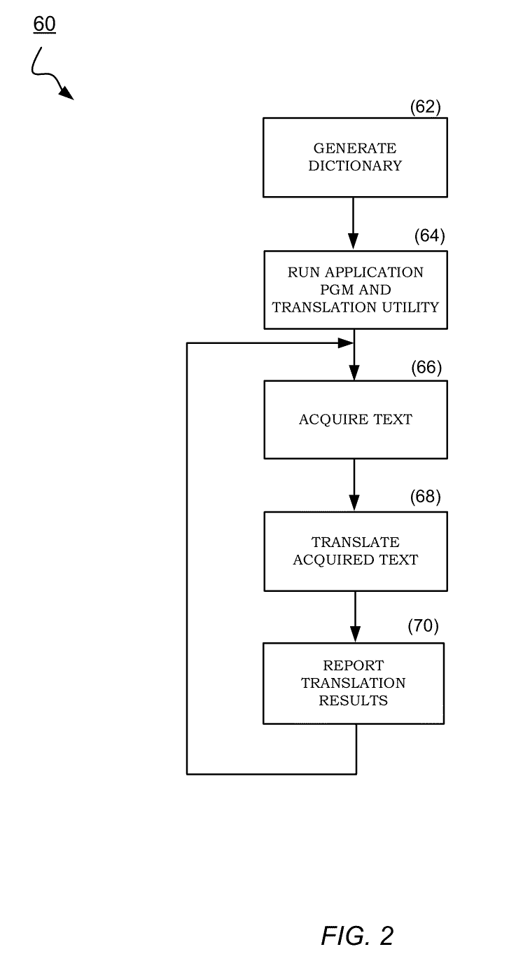

FIG. 2 shows an embodiment of a process 60 for automatic human language translation. In the description of the process 60, reference is made to various elements shown in FIG. 1. At step 62, a dictionary 46 is generated. Instead of or in addition to the dictionary 46, other embodiments can use different sources of translated texts, or an external translation service, for example, on the Internet. At step 64, a user (e.g., software developer) runs the application program 40 and the translation utility program 42. Any amount of time may lapse between the generation of the dictionary 46 and the subsequent running of the application program 40 and translation utility program 42. Execution of the application program 40 results in the display of localized user-interface elements, such as images and text, on the display screen 22.

With a user-input device 24, a user isolates localized text displayed on the display screen 22 and the translation utility program 42 acquires (step 66) the localized text. In one embodiment, the translation utility program 42 uses Microsoft's Windows™ API and the Microsoft UI Automation API to acquire text at a current mouse cursor position. The translation utility program 42 uses these APIs to track the position of the mouse pointer on a periodic basis (e.g., every 100 milliseconds), and to obtain the text at the current mouse position using the Microsoft UI Automation API. Use of the Microsoft UI Automation API thus generally enables the translation utility program 42 to interact with the application program 40 (or with any application program that displays text) without having to make any modifications to the application program to enable or support the interaction.

In one embodiment, the Microsoft UI Automation API also acquires the resource identifier associated with the captured localized text. This acquired resource identifier can serve as a key into the dictionary 46 for obtaining a translation of the localized text (provided the embodiment of dictionary 46 maps the resource identifiers to the target-language translations).

Instead of using the current cursor position to identify the localized text of interest, other user input technologies, such as eye-gaze tracking or a heat map system, can serve to detect where the user is currently looking and to acquire the localized text of interest. The ability to capture the localized text of interest can depend on the user-input technologies and underlying support in the running application program 40.

In response to the acquisition of the displayed localized text, an attempt is automatically made (step 68) at translating the acquired text from the localized language to a target language. The translation utility program 42 uses the acquired localized text as a key or index into the data structure of the dictionary 46. Alternatively, the translation utility program 42 can use a resource identifier (acquired with the localized text) as a key into the data structure of the dictionary 46, provided the embodiment of dictionary 46 maps resource identifiers to target-language translations. Zero, one, or more matches result from accessing the dictionary 46 with the acquired localized text. Each match corresponds to a translation of the localized text into the target language (e.g., an English language text).

The translation utility program 42 presents (step 70) the translation results to the user, for example, by display on the display screen 22. In one embodiment, the translation results presented include the original (acquired) localized text, the number of matches, each matching translation in target language, information about each match, and ancillary information, such as current cursor coordinates, the identity of the running application program, and type of control feature (i.e., resource) of the application program being translated. Other embodiments can display more or less or different information.

In one embodiment, the translation can include parameterized texts containing values substituted at run-time. Consider, for example, that the application program 40 requires displaying a message to the user containing text and numeric values (e.g., “The temperature 50° C. is out of range”), and that the numeric values can vary at run time. The application program 40 contains a localizable resource into which parameter values can be substituted at run time (optionally with formatting) through a series of placeholders or tokens, for example, “The temperature {1}° C. is out of range”. The {1} is a placeholder for the value that is substituted. At run-time, the application program 40 substitutes the {1} placeholder with the numeric value (of 50 in this example). In another embodiment, the string is translated, but each placeholder remains untranslated in its place; to illustrate by example, in Spanish, “La temperatura de {1}° C. está fuera de rango”, or, in Japanese, “ [symbol] {1}° C. [symbol] ”, Complex substitutions involving multiple placeholders and parameters and non-numeric substitutions (in addition to or instead of numeric value substitutions) can also be performed.

In response to the detection of a new focus of the user's interest on the display screen 22, the process 60 returns to step 66.

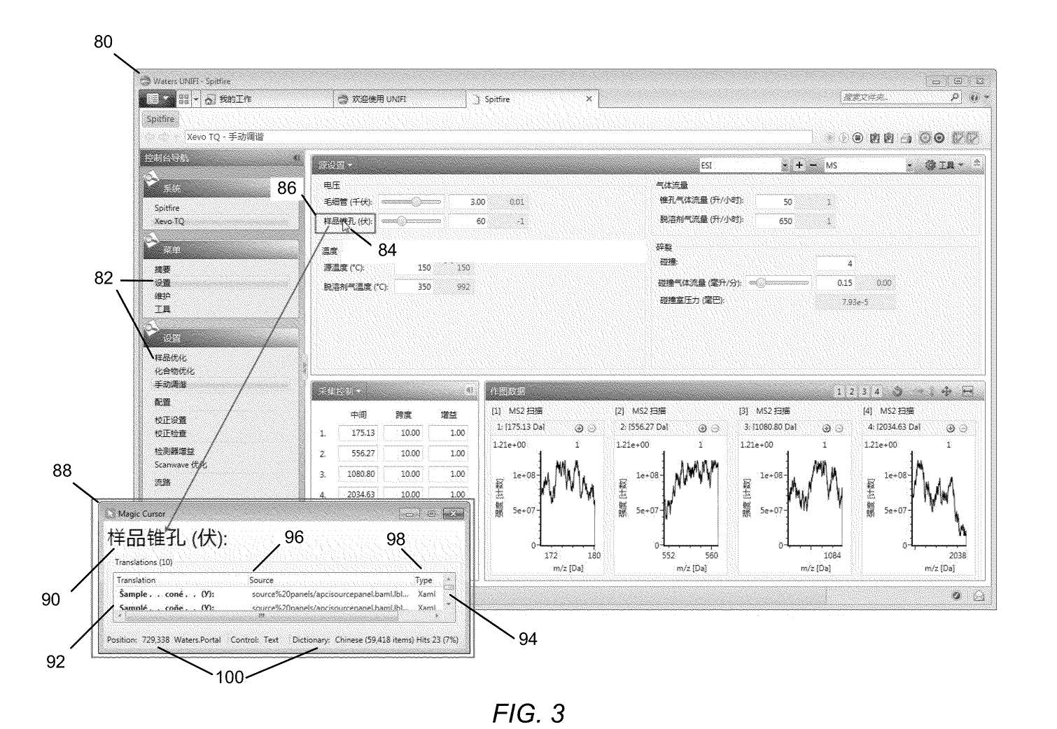

FIG. 3 shows an example of a user interface 80 that appears on the display screen 22 during the execution of the application program 40. The user interface 80 includes various user-interface elements including several instances of text 82 in a localized language (here, for example, Chinese). In this example, the current position of the cursor 84 is over a particular localized text (for identification purposes, bounded by a box 86). The translation utility program 42 acquires the localized text under the cursor 84 and produces a translation user interface 88.

Displayed in the translation user interface 88 is the acquired localized text 90 and each translation 92 of the localized text 90 found in the dictionary 46 (FIG. 1). In this example, ten (10) translations 92 of the localized text 90 are identified and displayed within a window of the translation user interface 88. Each translation 92 in this example appears in pseudo-English, from which the user is presumably able to infer the English counterpart. In another embodiment, each translation 92 can appear in plain (non-pseudo) English. A user can use the scroll bar 94 to scroll up and down through the list of translations 92. The origin or source 96 within the application program 40 and the source type 98 can also be listed for each translation 92. The origin of the translation text can be used a part of a mechanism to verify the translation process. The translation user interface 88 can present other information 100, including the current cursor position (screen coordinates), the identity of the application program, and the dictionary language (e.g., here, Chinese). If no matching translation is found for the captured localized text 90, the translation user interface 88 can indicate that no translations are available. This information can serve to identify an omission in the dictionary 46 or in the process of generating the dictionary 46.

The contents of the translation user interface 88 change dynamically in real time as the cursor 84 moves over other user-interface elements displayed in the application user interface 80. In one embodiment, the translation utility program 42 translates localized text unsupported by the application program 40, for example, messages displayed to the user by the operating system of the computer device 10 or by other applications running on the computer device 10.

In addition, the translation utility program 42 can have an application program interface that allows queries to be made on the underlying data structures (i.e., the dictionary 46). The queries can be used to identify similar or duplicate messages (e.g., different localized texts with the same English translation or different English translations for the same localized text). Duplicate message detection can thus serve to identify potential inconsistencies in the original adaptation process of the application program 40 (based on the presupposition that the same English texts should translate to the same equivalent localized texts, and vice versa).

As will be appreciated by one skilled in the art, aspects of the present invention may be embodied as a system, method, and computer program product. Thus, aspects of the present invention may be embodied entirely in hardware, entirely in software (including, but not limited to, firmware, program code, resident software, microcode), or in a combination of hardware and software. All such embodiments may generally be referred to herein as a circuit, a module, or a system. In addition, aspects of the present invention may be in the form of a computer program product embodied in one or more computer readable media having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired, optical fiber cable, radio frequency (RF), etc. or any suitable combination thereof.

Computer program code for carrying out operations for aspects of the present invention may be written in any combination of one or more programming languages, including an object oriented programming language such as JAVA, Smalltalk, C#, C++, and Visual C++ or the like and conventional procedural programming languages, such as the C and Pascal programming languages or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may execute entirely on a user's computer, partly on the user's computer, as a stand-alone software package, partly on the user's computer and partly on a remote computer or entirely on a remote computer or server. Any such remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Aspects of the described invention may be implemented in one or more integrated circuit (IC) chips manufactured with semiconductor-fabrication processes. The maker of the IC chips can distribute them in raw wafer form (on a single wafer with multiple unpackaged chips), as bare die, or in packaged form. When in packaged form, the IC chip is mounted in a single chip package, for example, a plastic carrier with leads affixed to a motherboard or other higher level carrier, or in a multichip package, for example, a ceramic carrier having surface and/or buried interconnections. The IC chip is then integrated with other chips, discrete circuit elements, and/or other signal processing devices as part of either an intermediate product, such as a motherboard, or of an end product. The end product can be any product that includes IC chips, ranging from electronic gaming systems and other low-end applications to advanced computer products having a display, an input device, and a central processor.

Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It is be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method of performing automatic human language translation, the method comprising:
displaying localized text in a first language on a screen of a computer device in response to execution of an application program;
detecting user interest in the localized text;
acquiring the localized text from the screen of the computer device in automatic response to detecting the user interest in the localized text;
obtaining, in automatic response to acquiring the localized text from the screen, one or more translations in a second language for the localized text from a dictionary; and
reporting each obtained translation for the localized text.

2. The method of claim 1, wherein obtaining the one or more translations in a second language for the localized text includes using the acquired localized text as a key to search for matches in the dictionary.

3. The method of claim 1, further comprising generating the dictionary from one or more glossaries, the one or more glossaries mapping resource identifiers to localized text in the first language and to localized text in the second language, each resource identifier being associated with a resource displayed by the execution of the application program.

4. The method of claim 3, wherein the one or ore glossaries provide a bound on the mappings of the dictionary from localized text in the first language to the one or more translations in the second language.

5. The method of claim 1, further comprising replacing the dictionary with a new dictionary that maps localized text in the first language to one or more translations in a third language in order to translate the acquired localized text into the one or more translations in the third language.

6. The method of claim 1, further comprising acquiring a resource identifier associated with the acquired localized text in automatic response to detecting the user interest in the localized text, and
wherein obtaining the one or more translations in a second language for the localized text includes using the resource identifier associated with the acquired localized text as a key to search for matches in the dictionary.

7. The method of claim 1, wherein the one or more translations in the second language includes pseudo-translated text.

8. The method of claim 1, wherein detecting user interest in the localized text includes one or more of tracking a current position of a cursor on the screen of the computer device, determining a focus of a gaze of the user upon the screen of the computer device, and detecting a touch of the screen of the computer device.

9. The method of claim 1, wherein reporting each obtained translation for the localized text includes displaying each obtained translation on the screen of the computer device.

10. The method of claim 9, further comprising displaying with each displayed translation an associated location in the application program where the acquired localized text is used.

11. The method of claim 1, further comprising displaying screen coordinates on the screen of the computer device where the acquired localized text appears.

12. The method of claim 1, wherein obtaining one or more translations in a second language for the localized text occurs locally on the computer device.

13. The method of claim 1, wherein the computer device is configured to perform one or more of controlling an analytical instrument and using data from the analytical instrument.

14. The method of claim 1, wherein the application program is configured to execute in a regulated environment.

15. A computer device comprising:
a display screen;
memory storing program code of an application program, program code of a translation utility, and a dictionary containing mappings of localized text in a first language to translated text in a second language; and
a processor executing program code of the application program configured to display localized text in the first language on the display screen, the processor further executing program code of the translation utility configured to detect user interest in the localized text, to acquire the localized text from the display screen in automatic response to detecting the user interest in the localized text, to obtain one or more translations in the second language for the localized text from the dictionary in automatic response to acquiring the localized text from the screen, and to report each obtained translation for the localized text.

16. The computer device of claim 15, wherein the processor further executes program code of the translation utility configured to use the acquired localized text as a key to search for matches in the dictionary.

17. The computer device of claim 15, further comprising one or more glossary data structures, the one or more glossary data structures mapping resource identifiers to localized text in the first language and to localized text in the second language, each resource identifier being associated with a resource displayed by the execution of the application program, the dictionary being generated from a combination of the one or more glossary data structures.

18. The computer device of claim 17, wherein the one or more glossary data structures provide a bound on the mappings of the dictionary from localized text in the first language to the one or more translations in the second language.

19. The computer device of claim 15, wherein the processor further executes program code of the translation utility configured to replace the dictionary with a new dictionary that maps localized text in the first language to one or more translations in a third language in order to translate the acquired localized text into the one or more translation in the third language.

20. The computer device of claim 15, wherein the processor further executes program code of the translation utility configured to acquire a resource identifier associated with the acquired localized text in automatic response to detecting the user interest in the localized text, and
wherein the processor further executes program code of the translation utility configured to use the resource identifier associated with the acquired localized text as a key to search for matches in the dictionary.

21. The computer device of claim 15, wherein the localized text in the second language includes pseudo-translated text.

22. The computer device of claim 15, wherein the program code of the translation utility includes one or more of program code configured to track a current position of a cursor on the screen of the computer device, program code configured to determine a focus of a gaze of the user upon the screen of the computer device, and program code configured to detect a touch of the screen.

23. The computer device of claim 15, wherein the program code of the translation utility includes program code configured to display each obtained translation on the display screen of the computer device.

24. The computer device of claim 23, wherein the program code configured to display each obtained translation on the display screen of the computer device includes program code configured to display, for each displayed translation, a location in the application program where the acquired localized text is used.

25. The computer device of claim 24, wherein the program code configured to display each obtained translation on the display screen of the computer device includes program code configured to display, for each displayed translation, screen coordinates on the display screen where the acquired localized text appears.

26. The computer device of claim 15, wherein the program code of the translation utility is further configured to obtain each translation locally on the computer device

27. The computer device of claim 15, wherein the processor further executes program code configured to perform one or more of controlling an analytical instrument and using data from the analytical instrument.

28. The computer device of claim 15, wherein the application program is configured to execute in a regulated environment.

29. A computer program product for performing automatic human language translation, the computer program product comprising:
a computer-readable storage medium having computer-readable program code embodied therewith, the computer-readable program code comprising:
computer-readable program code configured to detect user interest in localized text displayed in a first language on a screen of a computer device in response to an execution of an application program;
computer-readable program code configured to acquire the localized text from the screen of the computer device in automatic response to detecting the user interest in the localized text;
computer-readable program code configured to obtain, in automatic response to acquiring the localized text from the screen, one or more translations in a second language for the localized text from a dictionary; and
computer-readable program code configured to report each obtained translation for the localized text.

30. The computer program product of claim 29, wherein the computer-readable program code configured to obtain one or more translations in a second language for the localized text includes computer-readable program code configured to use the acquired localized text as a key to search for matches in the dictionary.

31. The computer program product of claim 29, further comprising computer-readable program code configured to generate the dictionary from one or more glossaries, the one or more glossaries mapping resource identifiers to localized text in the first language and to localized text in the second language, each resource identifier being associated with a resource displayed by the execution of the application program.

32. The computer program product of claim 31, wherein the one or more glossaries provide a bound on the mappings of the dictionary from localized text in the first language to the one or more translations in the second language.

33. The computer program product of claim 29, further comprising computer-readable program code configured to replace the dictionary with a new dictionary that maps localized text in the first language to one or more translations in a third language in order to translate the acquired localized text into the one or more translations in the third language.

34. The computer program product of claim 29, further comprising computer-readable program code configured to acquire a resource identifier associated with the acquired localized text in automatic response to detecting the user interest in the localized text, and
wherein the computer-readable program code configured to obtain one or more translations in a second language for the localized text includes computer-readable program code configured to use the resource identifier associated with the acquired localized text as a key to search for matches in the dictionary.

35. The computer program product of claim 29, wherein the one or more translations in the second language includes pseudo-translated text.

36. The computer program product of claim 29, wherein the computer-readable program code configured to detect user interest in the localized text includes one or more of computer-readable program code configured to track a current position of a cursor on the screen of the computer device, computer-readable program code configured to determine a focus of a gaze of the user upon the screen of the computer device, and computer-readable program code configured to detect touch on the screen of the computer device.

37. The computer program product of claim 29, wherein the computer-readable program code configured to report each obtained translation for the localized text includes computer-readable program code configured to display each obtained translation on the screen of the computer device.

38. The computer program product of claim 37, further comprising computer-readable program code configured to display with each displayed translation a location in the application program where the acquired localized text is used.

39. The computer program product of claim 37, further comprising computer-readable program code configured to display screen coordinates on the screen of the computer device where the acquired localized text appears.

40. The computer program product of claim 29, wherein the computer-readable program code configured to obtain one or more translations in a second language for the localized text obtains each translation locally on the computer device.

41. The computer program product of claim 29, wherein the computer device includes computer-readable program code configured to perform one or more of controlling an analytical instrument and processing data from the analytical instrument.

42. The computer program product of claim 29, wherein the application program is configured to execute in a regulated environment.
